(19) United States
(12) Patent Application Publication
(10) Pub. No.: US 2017/0175435 A1
(43) Pub. Date: Jun. 22, 2017

(54) Method for Tinting of the Double-Glass Pane

(71) Applicants: George CHECHELASHVILI, Tbilisi (GE); Ivane CHKHAIDZE, Tbilisi (GE)

(72) Inventors: George CHECHELASHVILI, Tbilisi (GE); Ivane CHKHAIDZE, Tbilisi (GE)

(21) Appl. No.: 15/378,393

(22) Filed: Dec. 14, 2016

(30) Foreign Application Priority Data
Dec. 17, 2015 (GE) AU201514018

(51) Int. Cl. E06B 3/67; E06B 3/34; E05D 15/02; E06B 3/24

(52) U.S. Cl. CPC E06B 3/6715; E06B 3/24; E06B 3/34; E05D 15/02

(57) ABSTRACT

A window having a window frame, a leaf frame nested in the frame, the leaf frame framing a double-glass pane; a reservoir entirely disposed in a horizontal element of the leaf frame of the double-glass pane, the reservoir being filled with a tinting substance; horizontal axes disposed at midpoints of a height of vertical elements of the leaf frame, the horizontal axes serving to couple the leaf frame with the window frame; the leaf frame being configured to rotate about said horizontal axes by 180° relative to the window frame to cause the tinting substance to move by gravity from the reservoir into the double-glass pane, wherein a capacity of the reservoir is hermetically coupled to an internal capacity of the double-glass pane. The tinting substance is liquid or solid homogeneous powdery mass consisting of spherical crumbs.

### RELATED APPLICATIONS

This application claims priority to Georgian Patent Application No. au 2015 14018, filed December 17, 2015, which is incorporated herein by reference in its entirety.

### FIELD OF THE INVENTION

The invention relates to the field of construction, namely to the glass window or a door having a feature protecting from the light.

### BACKGROUND OF THE INVENTION

There is known a method of tinting of a hermetic double-glass pane, which provides filling of the double-glass pane with a colored liquid by means of hydrocylinders, which are not of a small size and are located outside of the frame and their operation requests some physical effort /1/.

### SUMMARY OF THE INVENTION

The presented invention provides the method of rapid tinting of the double-glass pane placed in a door or window leaf together with a rapid recovery of its transparency without using any additional facilities from the existing external space. The presented device does not contain electronic instruments and, accordingly, does not require an electric power source.

The technical result of the invention is a simplification and an increase of the rate of the transparency change of the double-glass pane placed in a door or a window leaf without worsening the quality of that transparency.

The technical result is achieved by a reservoir which is constructed in a lower horizontal element of the leaf frame of the double-glass pane and inserted in the window or door leaf frame, and wherein the double-glass pane tinting substance is contained. The capacity of the said reservoir is equal or greater to the capacity of the space existing between the glasses. To put the window or door leaf in a desired position, the reservoir is rotating by 180° about the central horizontal axis in vertical plane relative to the immovable outer frame.

Tinting of the double-glass pane is carried out by any non-transparent substance. It is possible to use liquid or solid homogeneous powdery (sandy) mass consisting of spherical crumbs.

The internal capacity of the double-glass pane is then filled with non-transparent substance or is emptied due to gravitation.

The non-transparent substance moves in the united space created by the reservoir arranged in the double-glass pane and its frame's one of the horizontal elements. The said space is formed as a vessel having two equal capacity containers hermetically isolated from the environment, and connected to each other.

An object of the present invention is to provide a window or a door comprising an outer frame, a leaf frame nested in the frame, the leaf frame framing a double-glass pane; a reservoir entirely disposed in a horizontal element of the leaf frame of the double-glass pane, the reservoir being filled with a tinting substance; horizontal axes disposed at midpoints of a height of vertical elements of the leaf frame, the horizontal axes serving to couple the leaf frame with the outer frame; the leaf frame being configured to rotate about said horizontal axes by 180° relative to the outer frame to cause the tinting substance to move by gravity from the reservoir into the double-glass pane, wherein a capacity of the reservoir is hermetically coupled to an internal capacity of the double-glass pane. The capacity of the reservoir and the internal capacity of the double-glass pane are hermetically isolated from environment. The window, according to claim 1, wherein the capacity of the reservoir is greater or equal to the capacity of a space between the glasses.

### BRIEF DESCRIPTION OF THE DRAWINGS

The invention is presented in two figures.

FIG. 1 shows a window or door leaf frame with a transparent double-glass pane; and

FIG. 2 shows the window or door leaf frame with a non-transparent double-glass pane.

### DETAILED DESCRIPTION OF THE PREFERRED EMBODIMENTS

In the frame of window or door 1 there is inserted a window or door leaf frame 2, wherein is inserted a double-glass pane 3, which comprises two glasses distanced from each other by 0,5÷3 mm and connected by three sides uncontinuously. In one of the horizontal elements of the leaf frame 2 there is constructed a reservoir 4 which is connected to the space between the glasses by holes 5, filled with a tinting substance and except the holes connection to the double-glass is duly protected on all sides from leaking of the tinting substance which capacity is equal or greater than the capacity of the space between the double-glass pane. There are fixed horizontal axis 6 in the height of the vertical elements of the window or door leaf 2 frame on the midpoints by which this frame is connected to the window's or door's immovable frame 1 for rotating the vertical plane about said axes by 180° relative to the immovable frame in order to put the window or door leaf frame to the desired position.

The double-glass pane is used by following:

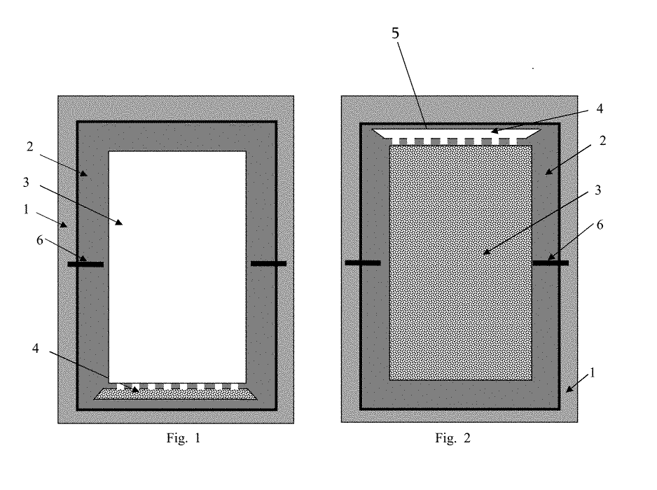

Initially filled with tinting substance the reservoir 4 is placed in the lower part of the window leaf 2 (FIG. 1). At this time the double-glass pane 3 is empty and transparent. After turning over by 180° through the vertical axis of the window leaf by force of gravity (unit weight) the tinting substance flows down (pours into) in the double-glass pane and fills it (FIG. 2). In this position the double-glass pane is filled with tinting substance and is non-transparent.

It is possible to fix the movable and immovable frames in the desired position towards each other by using any ordinary mechanical locking devices (are not shown on the figures).

The presented using of the double-glass pane is a preferable one compared with its other known analogues, because of simplicity of its use, needed no additional fittings and energy application, and in case of necessity the leaf by simple turning becomes tinted and transparent again. The tinting substance reservoir constructed in the horizontal element of the leaf is fully protected from three sides, but from the opened forth side is hermetically connected to the space between the glasses. The tinting substance is collected in the internal hollow space of the window or door leaf's lower horizontal element, imperceptible from outer glance, by force of gravity when substance flows out from the double-glass pane connected to it and the double-glass pane becomes transparent by itself or vice-versa the tinting substance fills the double-glass pane and it becomes tinted.

### REFERENCES

1. WO2008/111924

What is claimed is:

1. A window or a door comprising;
an outer frame, a leaf frame nested in the frame, the leaf frame framing a double-glass pane;
a reservoir entirely disposed in a horizontal element of the leaf frame of the double-glass pane, the reservoir being filled with a tinting substance;
horizontal axes disposed at midpoints of a height of vertical elements of the leaf frame, the horizontal axes serving to couple the leaf frame with the outer frame;
the leaf frame being configured to rotate about said horizontal axes by 180° relative to the outer frame to cause the tinting substance to move by gravity from the reservoir into the double-glass pane, wherein a capacity of the reservoir is hermetically coupled to an internal capacity of the double-glass pane.

2. The window, according to claim 1, wherein the capacity of the reservoir and the internal capacity of the double-glass pane are hermetically isolated from environment.

3. The window, according to claim 1, wherein the capacity of the reservoir is greater or equal to the capacity of a space between the glasses.
